(19) United States
(12) Patent Application Publication
(10) Pub. No.: US 2024/0278933 A1
(43) Pub. Date: Aug. 22, 2024

(54) HELICOPTER LANDING PLATFORM

(71) Applicant: Raymond Butler, Port Lavaca, TX (US)

(72) Inventor: Raymond Butler, Port Lavaca, TX (US)

(21) Appl. No.: 18/111,151

(22) Filed: Feb. 17, 2023

(51) Int. Cl. B64F 1/00

(52) U.S. Cl. CPC B64F 1/007

(57) ABSTRACT

A helicopter landing platform that includes a platform having an outside frame and internal framework. The helicopter landing platform includes an equipment compartment. The helicopter landing platform includes two caster wheels attached to the platform that are adapted to provide mobility to the helicopter landing platform on a surface and two motorized wheels attached to the platform that that are adapted to provide mobility to the helicopter landing platform on a surface, each of the motorized wheels having a motor attached to the motorized wheel. The helicopter landing platform includes at least one battery. The helicopter landing platform includes a joystick control unit with a joystick. The helicopter landing platform includes an electrical control unit connected between the joystick control unit and the motorized wheels, the electrical control unit connected to the battery to provide power to the motorized wheels and to provide power to the joystick control unit.

### BACKGROUND

The present invention generally relates to helicopters. More specifically, the present invention relates to movement of helicopters on the ground.

Typical private helicopters have no easy way to be moved once on the ground. One way of moving a helicopter is to attach wheels after landing or have wheels that stay on the helicopter. Then, the helicopter is moved by hand like a wheelbarrow of sorts. It is very difficult to push around and maneuver a helicopter in this way. Another way is to use a movable platform with wheels, like a trailer and tow the trailer with a tow tractor. A tow trailer is difficult to position and must have a tractor to tow and maneuver. There is also a wheeled powered hydraulic lift-type adjustable jig which lifts the helicopter and then uses self-power to lift and move the unit while being steered with a tow bar type handle. The helicopter is moved to its storage position, lowered to the ground, and the jig is removed from the helicopter. There are many motorized tow vehicles available, but they must be carefully positioned under the helicopter, require raising and lowering, and much adjusting unique to the particular helicopter before moving. The tow vehicles available have complicated drive systems and use a detached Bluetooth-like controller which has no redundancy.

It is an object of the present invention to provide simple, less expensive and very maneuverable device to move a helicopter.

### SUMMARY

A helicopter landing platform that includes a platform having an outside frame and internal framework. The helicopter landing platform includes an equipment compartment. The helicopter landing platform includes two caster wheels attached to the platform that are adapted to provide mobility to the helicopter landing platform on a surface and two motorized wheels attached to the platform that that are adapted to provide mobility to the helicopter landing platform on a surface, each of the motorized wheels having a motor attached to the motorized wheel. The helicopter landing platform includes at least one battery. The helicopter landing platform includes a joystick control unit with a joystick. The helicopter landing platform includes an electrical control unit connected between the joystick control unit and the motorized wheels, the electrical control unit connected to the battery to provide power to the motorized wheels and to provide power to the joystick control unit.

### BRIEF DESCRIPTION OF DRAWINGS

FIG. 1 is a perspective top view of a helicopter landing platform according to the present invention.

FIG. 2 is a perspective top view of a helicopter landing platform according to the present invention.

FIG. 3 is a perspective bottom view of a helicopter landing platform according to the present invention.

FIG. 4 is a perspective top view of a helicopter landing platform according to the present invention.

FIG. 5 is a perspective bottom view of a helicopter landing platform according to the present invention.

FIG. 6 is a perspective bottom view of a helicopter landing platform according to the present invention.

FIG. 7 is a perspective view of a joystick control unit according to the present invention.

### DETAILED DESCRIPTION

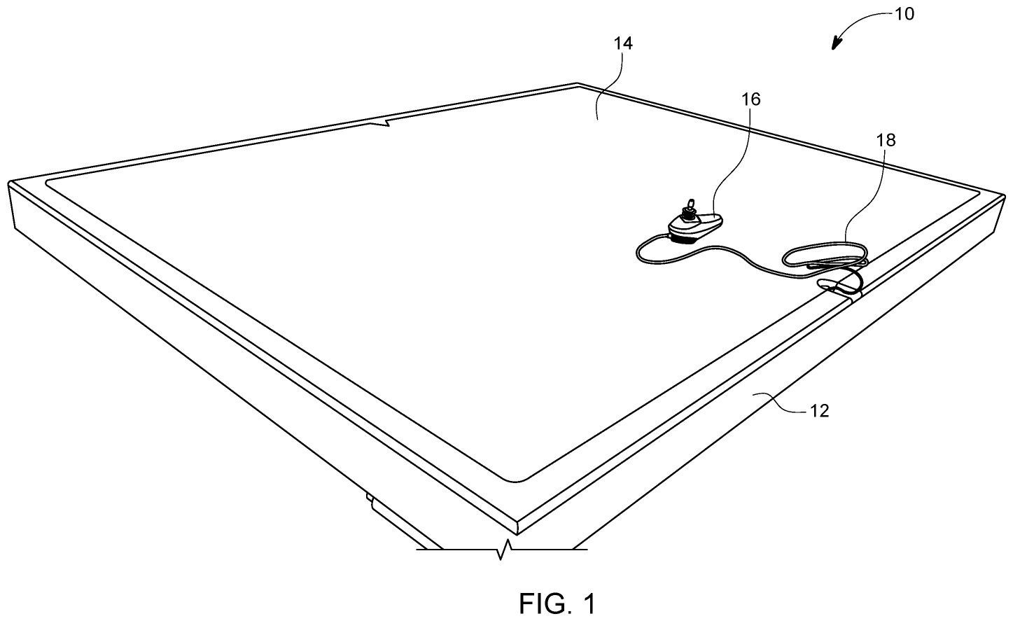

FIG. 1 shows a self-powered mobile helicopter landing platform 10. The helicopter landing platform uses a 24 volt electrical control joystick unit connected to variable speed motors at two wheels to allow full mobility of the platform. This allows movement similar to the maneuverability of a zero-turn mower. A joystick control unit is connected to the 24 volt electrical control unit by an eight foot long cable. The 24 volt electrical control unit is connected to a left variable speed motor at one wheel and right variable speed motor at another wheel. The power source is the combination of two series-wired deep cycle twelve volt batteries wired for quick-connect charging using a separate charging unit. The electric variable speed motors are 24 volt.

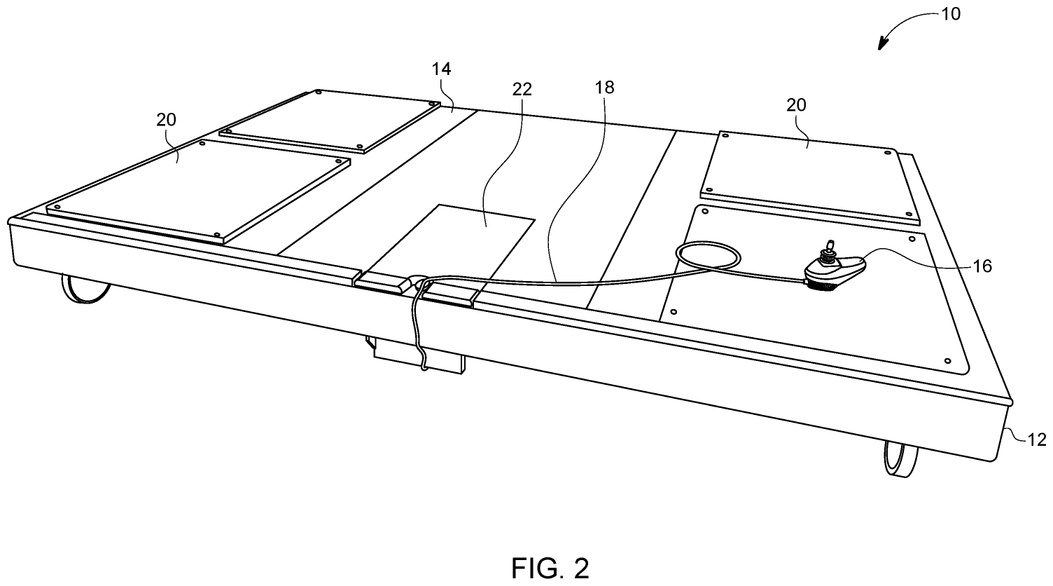

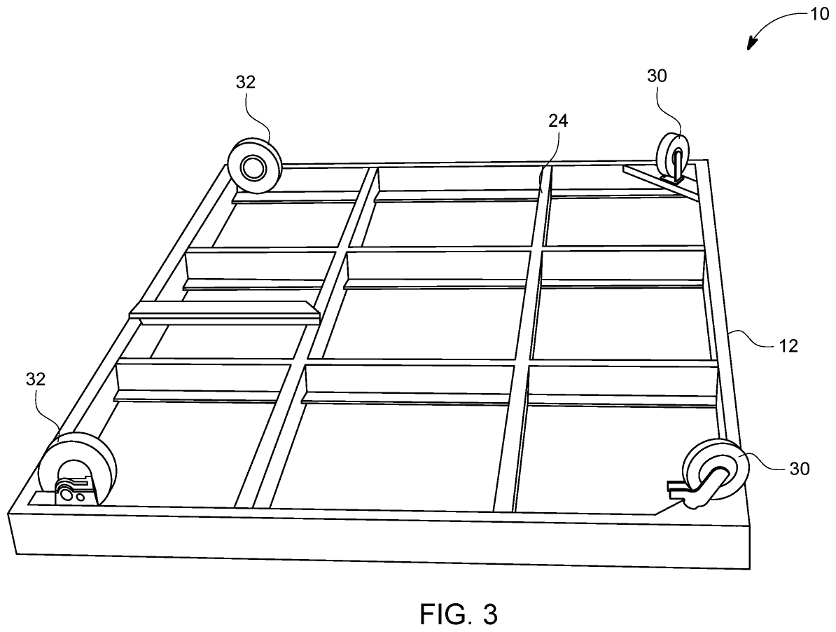

FIG. 1 shows a top view of the platform 10 having an outside frame 12, landing surface 14 and joystick control unit 16 with power cable 18 that attaches to an electrical control unit. FIG. 2 shows the platform 10 of FIG. 1 with protection padding 20 for helicopter contact with the platform 10 and a service door 22 to access the batteries and electronics of the electrical control joystick module. FIG. 3 shows a bottom view of the outside frame 12, internal frame work 24 and wheels attached to internal frame work 24 that provide support for weight of the helicopter.

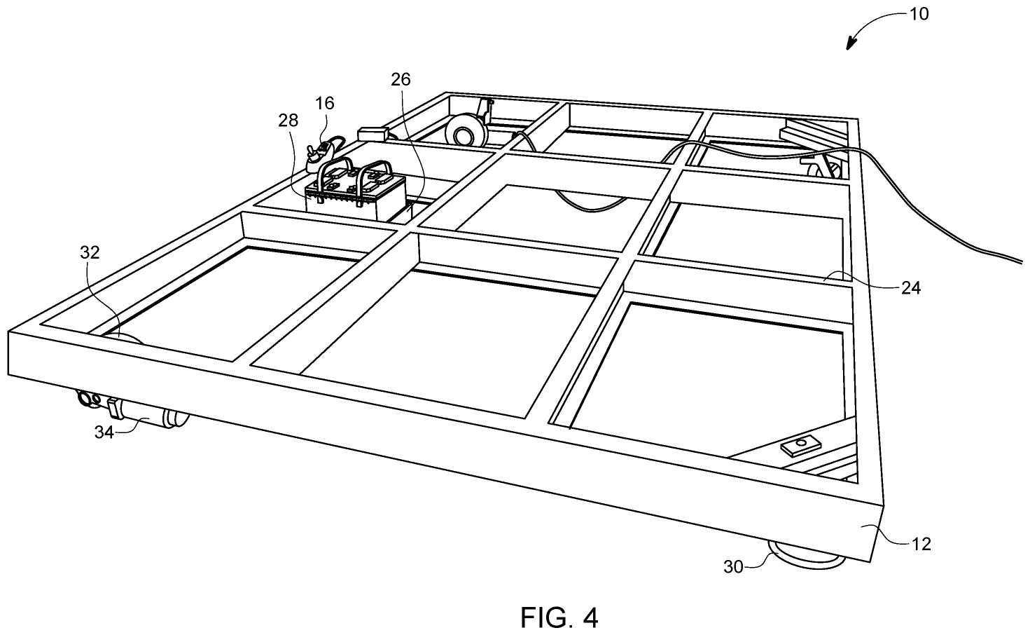

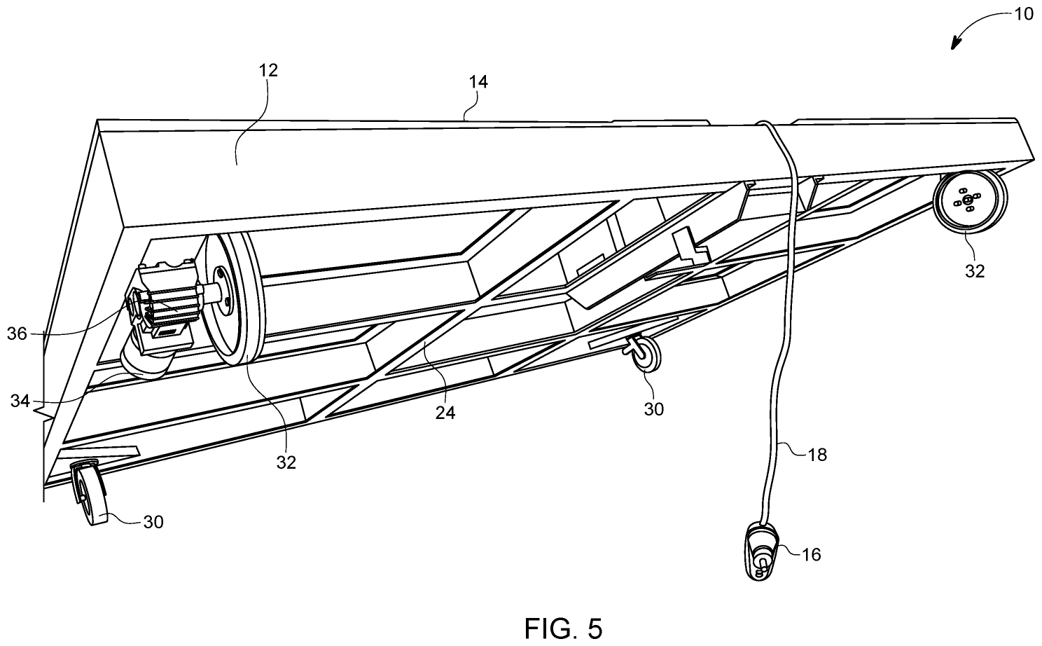

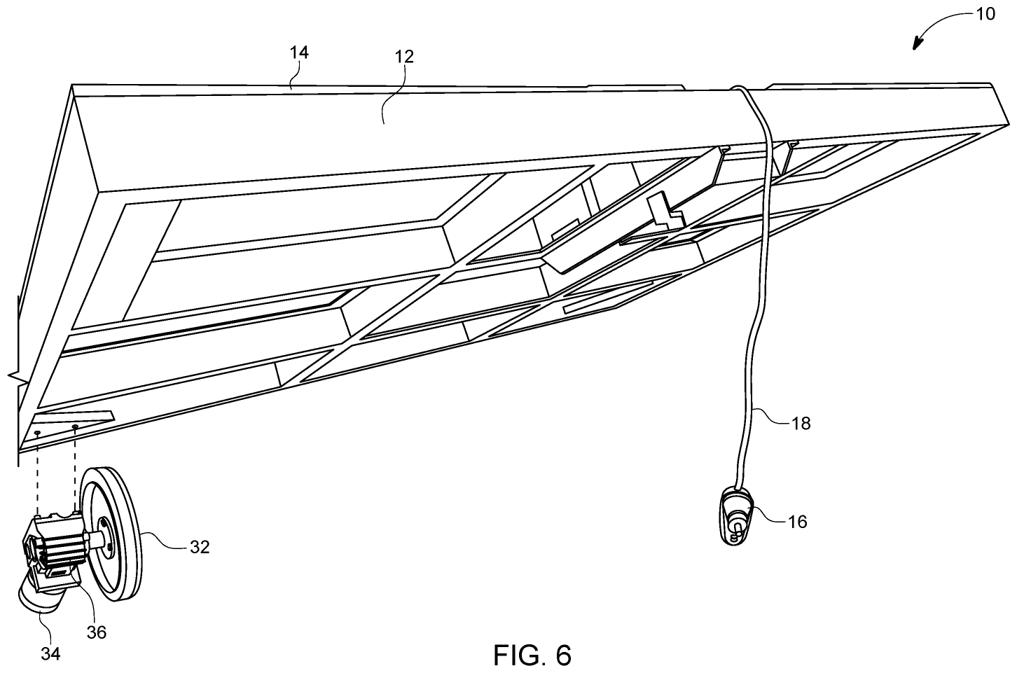

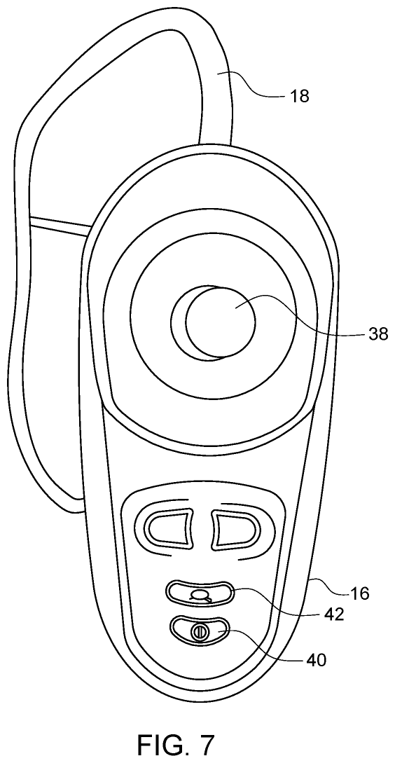

FIG. 4 shows the platform 10 of FIG. 1 with the landing surface 14 removed. FIG. 4 shows the equipment compartment 26 and batteries 28 that are located under the service door 22. FIG. 4 shows two caster wheels 30 and two motorized wheels 32. FIG. 5 shows a bottom view of the platform 10 with the two caster wheels 30 and two motorized wheels 32. Also shown in FIG. 5 is an example of an electric motor 34 and geared transmission 36 that attaches to the motorized wheels 32. The electric motor 34 drives the gear reduced transmission 32 and the transmission 32 drives the motorized wheel 32 to rotate. FIG. 6 shows an exploded view of the electric motor 34, geared transmission 36 and motorized wheel 32 removed from the internal framework 24 of the platform 10. FIG. 7 shows the joystick control unit 16 having a joystick 38, power button 40, off button 42, speed increase button 44 and speed decrease button 46. Each motor 34 includes variable speed circuitry is an integral part of the motor 34. The control of each of the left and right variable speed motors 34 is via the electrical control unit located in the equipment compartment 26. The electrical control unit is linked to the joystick 38. The joystick 38 and the electrical control unit controls the speed of each motor 34 by how far the joystick is moved and in what direction it is moved.

Operations of the platform 10 are achieved by using the joystick control unit 16. The power button 40 is activated to provide power to the motors 34. The desired speed range of the controller is selected by rotating the power button clockwise to increase and counterclockwise to decrease. Speed of the platform within the defined speed range is controlled by the amount of deflection of the joystick. The joystick 38 is then moved to direct the platform 10 to move in any one direction. Moving the joystick 38 up moves the platform 10 forward. Moving the joystick 38 back moves the platform 10 backwards. The electrical control unit commands the motors 34 to move the wheels 32 in the same direction when moving forward or backwards. Moving the joystick 38 to the left or right causes the platform 10 to move left or right. The electrical control unit commands the motors 34 to move the wheels 32 in opposite directions when moving left or right. The helicopter lands on the platform 10 to be moved around. Once the helicopter is moved to be stored into the hanger, it is ready for the next flight by just moving the helicopter on the platform 10 from the hangar out to the tarmac for takeoff.

In summary, the self-powered mobile helicopter landing platform 10 uses a very simple propulsion system consisting of two variable speed 24 volt motors 34, electrical control unit coupled to a programmable joystick controller 16. Other similar units depend on complex power systems using hydraulic and electric components that are bulky, prone to failure, and much more expensive. The self-powered mobile helicopter landing platform is also unique to other similar units in that its overall size allows for shipping overland without any disassembly. The self-powered mobile helicopter landing platform 10 is virtually maintenance-free due to aluminum chassis components that make up the outside frame 12 and the internal framework. The self-powered mobile helicopter landing platform 10 makes handling, positioning, and storing the helicopter much easier than any other method, as the pilot can actually sit in the helicopter and use the joystick controller 16 to move the helicopter as desired.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A helicopter landing platform, comprising:
a platform having an outside frame and internal framework;
an equipment compartment;
two caster wheels attached to said platform that are adapted to provide mobility to said helicopter landing platform on a surface;
two motorized wheels attached to said platform that that are adapted to provide mobility to said helicopter landing platform on a surface, each of said motorized wheels having a motor attached to said motorized wheel;
at least one battery;
a joystick control unit with a joystick;
an electrical control unit connected between said joystick control unit and said motorized wheels, said electrical control unit connected to said battery to provide power to said motorized wheels and to provide power to said joystick control unit.

2. The helicopter landing platform, of claim 1, wherein said outside frame and said internal framework are made of aluminum.

3. The helicopter landing platform, of claim 1, wherein said battery is a combination of two series-wired deep cycle twelve volt batteries wired for quick-connect charging using a separate charging unit.

4. The helicopter landing platform, of claim 1, further including a landing surface.

5. The helicopter landing platform, of claim 4, further including protection padding adapted for helicopter contact with said platform.

6. The helicopter landing platform, of claim 1, further including a service door as part of said equipment compartment to access said batteries and electrical unit.

7. The helicopter landing platform, of claim 1, wherein said motors are variable speed motors to allow full mobility of the platform to move as a zero turn.

8. The helicopter landing platform, of claim 7, further including a geared transmission between each of said motor and said motorized wheel, so that said motor drives said transmission and said transmission 32 drives said motorized wheel.

9. The helicopter landing platform, of claim 8, further including variable speed circuitry is an integral part of each said motor to allow said motors to move in the same direction or move in opposite directions.
